(19) United States
(12) Patent Application Publication
(10) Pub. No.: US 2008/0093939 A1
(43) Pub. Date: Apr. 24, 2008

(54) QUIET GEAR ASSEMBLY

(75) Inventor: Kam Ming Lam, Sheung Shui, NT (HK)

Correspondence Address: BAKER & MCKENZIE LLP, Pennzoil Place, South Tower, 711 Louisiana, Suite 3400, HOUSTON, TX, 77002-2716, US

(73) Assignee: EARLY LIGHT INTERNATIONAL CENTRE, No.9, Sheung Shui, NT (HK)

(21) Appl. No.: 11/758,415

(22) Filed: Jun. 5, 2007

Related U.S. Application Data
(60) Provisional application No. 60/853,993, filed on Oct. 24, 2006.
(60) Provisional application No. 60/853,903, filed on Oct. 23, 2006.

(51) Int. Cl. H02K 7/00

(52) U.S. Cl. 310/66

(57) ABSTRACT

A gear assembly with a first gear having a first coupling portion and a vibration absorbing adaptor inserted into the first coupling portion of the first gear. The first coupling portion and the adaptor are interlocking The adaptor also includes a second coupling portion. A second gear is inserted into the second coupling portion of the adaptor and is driven by the first gear. Additional gears may be driven by the second gear.

### CROSS REFERENCE TO RELATED APPLICATIONS PRIOR RELATED APPLICATIONS

This application claims priority over U.S. Provisional Application No. 60/853,993, filed Oct. 24, 2006, and U.S. Provisional Application No. 60/853,903, filed Oct. 23, 2006, which is incorporated herein in its entirety.

### FEDERALLY SPONSORED RESEARCH STATEMENT

Not applicable.

### REFERENCE TO MICROFICHE APPENDIX

Not applicable.

### BACKGROUND OF THE INVENTION

Existing designs for motor gearboxes that operate at or below 0.5 lb/in are characterized as having an assembly that generates noise from the motor itself and the high speed engagement of the gears. Development of a compact miniature gearbox that makes efficient use of space with a reduction in noise is sought.

### SUMMARY OF THE INVENTION

Embodiments of the invention provide a gear assembly having a first gear including a first coupling portion; a vibration absorbing adaptor coupled with the first coupling portion of the first gear including a second coupling portion; a second gear coupled with the second coupling portion of the adaptor and driven by the first gear; and a third gear driven by the second gear. The first coupling portion, the adaptor, the second coupling portion and the second gear are operably coupled to transfer torque from the first gear to the second gear. In some embodiments, the adaptor is integral to the first gear. In other embodiments, the adaptor is integral to the second gear.

The first gear, second gear and third gear may be spur gears, crown gears, bevel gears, helical gears, or combinations thereof. In some embodiments, the first gear, second gear and third gear are spur gears. In alternate embodiments, the first gear is a crown gear and the second

In another embodiment of the invention, the gear assembly also includes a small frame coupled to a housing by a plurality of vibration absorbing dampers. In another embodiment, the gear assembly also includes a DC motor driving the first gear.

### BRIEF DESCRIPTION OF THE DRAWINGS

FIG. 1 is an exploded view of an embodiment of the invention.

FIG. 2 is an exploded view of an alternate embodiment of the invention.

### DETAILED DISCUSSION OF EMBODIMENTS OF THE INVENTION

Like reference numerals designate identical or corresponding parts throughout the several views of the drawings. Features of the invention will become apparent in the course of the following description of embodiments of the invention, which are given only for illustration of the inventions and is not intended to be limiting thereof.

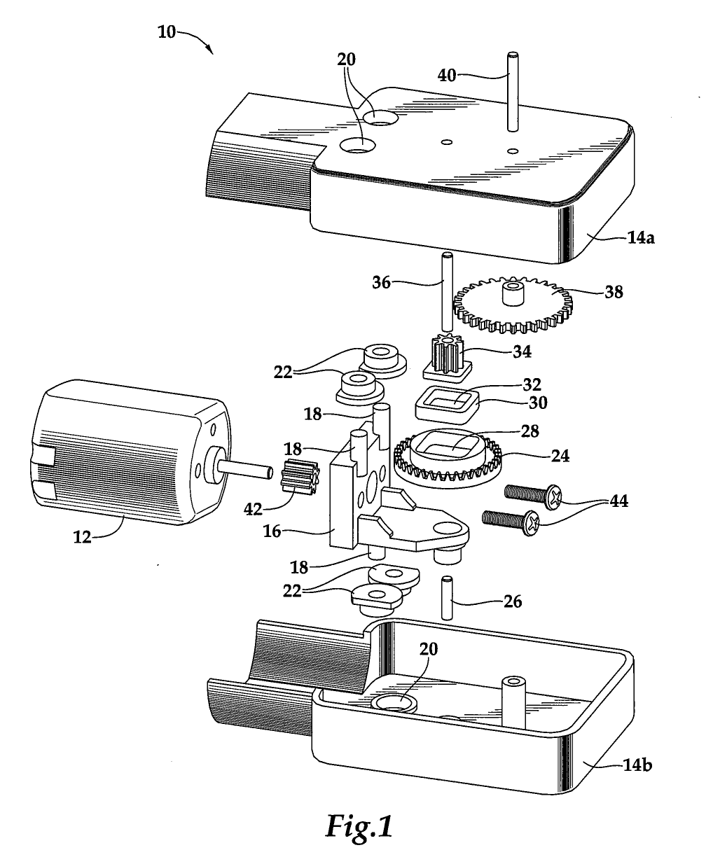

With reference to FIG. 1, a preferred embodiment of an invention for a gearbox 10 includes a motor 12, a housing 14 and a frame 16. Although the housing 14 is shown as having a top half 14a and a bottom half 14b, both having a rectangular cross-section, any housing 14 that is able to enclose the frame 16 and support the motor 12 may be used. The gearbox 10 is typically used in the manufacture of toys such as, but not limited to, robots, play sets, motor drive musical boxes with or without figurine movement, and those that include a movement function, but may have other uses such as in small fish tank pumps and the like. The housing 14 is preferably made of a plastic material, but may be made of any material that accommodates the purpose and use of the gearbox, such as resin, ceramic, or metal.

The frame 16 is preferably coupled to the housing 14 via a plurality of tabs 18. The plurality of tabs 18 may be inserted into a corresponding plurality of vibration absorbing dampers 22 prior to insertion into a plurality of recesses 20 located in the top housing 14a and the bottom housing 14b. The tabs 18 are preferably integral to and located on the frame 16 to accommodate their insertion into the recesses 20 in the housing 14. The frame 16 and tabs 18 are preferably made of plastic or an appropriate material to accommodate the purpose and use of the gearbox. Although the number of tabs 18, recesses 20, and dampers 22 shown is four, any number may be used to provide stable operation of the gearbox 10. The dampers 22 are preferably made of a sufficiently soft material that will absorb vibrations produced within the gear box 10. In a preferred embodiment, the soft material has a hardness between about 30-50 shore A. The soft material should also meet certain mechanical requirements such as heat resistance, chemical resistance, aging, environmental impact, etc. In some embodiments, the dampers 22 are made of thermoplastic rubber such as styrene-butadiene-styrene rubber (SBS), styrene-ethylene-butadiene-styrene rubber (SEBS), or injection grade silicone rubber. In an alternate embodiment, the dampers 22 are integral to the tabs 18. To be integral to the tabs 18, the vibration absorbing material of the dampers 22 may be applied to the tabs 18. Application of the damper 22 vibration absorbing material may be by such means as, but not limited to, painting the tabs 18 or coating, either partially or completely, the tabs 18.

In a preferred embodiment, the frame 16 is coupled to a first gear 24 by an axle 26. The axle 26 may also couple the frame 16 to the bottom housing 14b. The first gear 24 preferably includes a first coupling portion 28. A vibration absorbing adaptor 30 is coupled with the first coupling portion 28. The adaptor 30 contains a second coupling portion 32 for coupling with a second gear 34. Thus, the first gear 24 and the second gear 34 are operably coupled or interlocked via the adaptor 30. The adaptor 30 is preferably designed to transfer the torque from the first gear 24 to the second gear 34. The first gear 24 or second gear 34 may be any gear such as, but not limited to, spur gears, crown gears, bevel gears, helical gears or combinations thereof. The first gear 24, the adaptor 30, and the second gear 34 are preferably further coupled by an axle 36. The axle 36 may also be coupled to the top housing 14a. In a preferred embodiment, the axle 36 is press fit into a post hole of the top housing 14a and the axle 36, the second gear 34, the adaptor 30, the first gear 24, the frame 16 and axle 26 are assembled along the same center line.

In a preferred embodiments, the first coupling portion 28 is a recess into which the adaptor 30 is inserted and the second coupling portion 32 is a recess into which the second gear 34 is inserted. In alternate embodiments, the first coupling portion 28 is a tab which is inserted into the adaptor 30 and the second coupling portion 32 is a tab which is inserted into which the second gear 34.

The adaptor 30 absorbs vibration and also transfers torque from the first gear 28 to the second gear 34. Therefore, the adaptor 30 may be of a soft material, such as plastic, rubber or other material that is soft enough to absorb vibration, but strong enough to transfer torque. In a preferred embodiment, the soft material has a hardness between about 30-50 shore A. The soft material should also meet certain mechanical requirements such as heat resistance, chemical resistance, aging, environmental impact, etc. In some embodiments, the adaptor 30 is made of thermoplastic rubber such as styrene-butadiene-styrene rubber (SBS), styrene-ethylene-butadiene-styrene rubber (SEBS), or injection grade silicone rubber.

The first coupling portion 28, the adaptor 30 and the second coupling portion 32 may be any shape that does not allow substantial slippage of the adaptor 30. Thus, the first coupling portion 28, the adaptor 30 and the second coupling portion 32 may be any polygonal shape in cross-section, such a triangular, square, hexagonal, or irregular. In a preferred embodiment, the second coupling portion 32 and second gear 34 have a cross-section that is substantially the same, one slightly smaller than the other, to allow a substantially tight fit. In some embodiments, the second gear 34 includes an insertion ledge having substantially the same cross-section as the second coupling portion 32. In alternate embodiments, the first coupling portion 28 and adaptor 30 do not have corresponding polygonal shapes. The size of the adaptor 30 may be limited by the diameter of the first gear 24 or second gear 34. The adaptor 30 may be an independently molded single piece, but may also be integral to the first gear 24 or the second gear 34. To be integral to the first gear 24 or the second gear 34, the vibration absorbing material of the adaptor 30 may be applied to either the first gear 24 or the second gear 34. Application of the adaptor 30 vibration absorbing material may be by such means as, but not limited to, painting the first gear 24 or the second gear 34 or coating, either partially or completely, the first gear 24 or the second gear 34.

In a preferred embodiment, a third gear 38 is driven by the second gear 34. The third gear 38 is preferably coupled to the top housing 14 via an axle 40. The third gear 38 may be any gear such as, but not limited to, spur gears, crown gears, bevel gears, or helical gears.

The gears 24, 34, and 38 are preferably made of a plastic material such as, but not limited to, injection grade polyacetel (POM) or polyamide (PA). The gears 24, 34, and 38 may be of the same kind or some combination of gears. The gears 24, 34, and 38 are preferably used to provide gear reduction in a variety of applications. In alternate embodiments, the gears, 24, 34, and 38 are made of any material that is appropriate and accommodates the purpose and use of the gearbox.

The axles 26, 36, and 40 are preferably made of a metal material such as, but not limited to, iron. In alternate embodiments, the axles 26, 36, and 40 are made of any material that is appropriate and accommodates the purpose and use of the gearbox. Although axles 26, 36, and 40 are shown coupling the internal parts of the gearbox to the housing 14, other appropriate mechanisms may be used. In most embodiments, the axles 26, 36, and 40 will be metal, ceramic or a very hard plastic or resin.

The motor 12 may be coupled to the first gear 24 via a pinion 42. The pinion 42 preferably drives the first gear 24. The pinion 42 is preferably made of a plastic material such as, but not limited to, injection grade polyacetel (POM) or polyamide (PA). In alternate embodiments, the pinion 42 is made of any material that is appropriate and accommodates the purpose and use of the gearbox. The motor 12 is preferably a DC motor having a torque less than or equal to about 200 g/cm. In alternate embodiments, the motor may have a greater torque or be an AC motor (?). The motor 12 is preferably coupled to the frame 16 by a plurality of motor mounting screws 44. Although screws are shown, any mounting mechanism that would attach the motor 12 to the frame 16 that is appropriate and accommodates the purpose and use of the gearbox may be used.

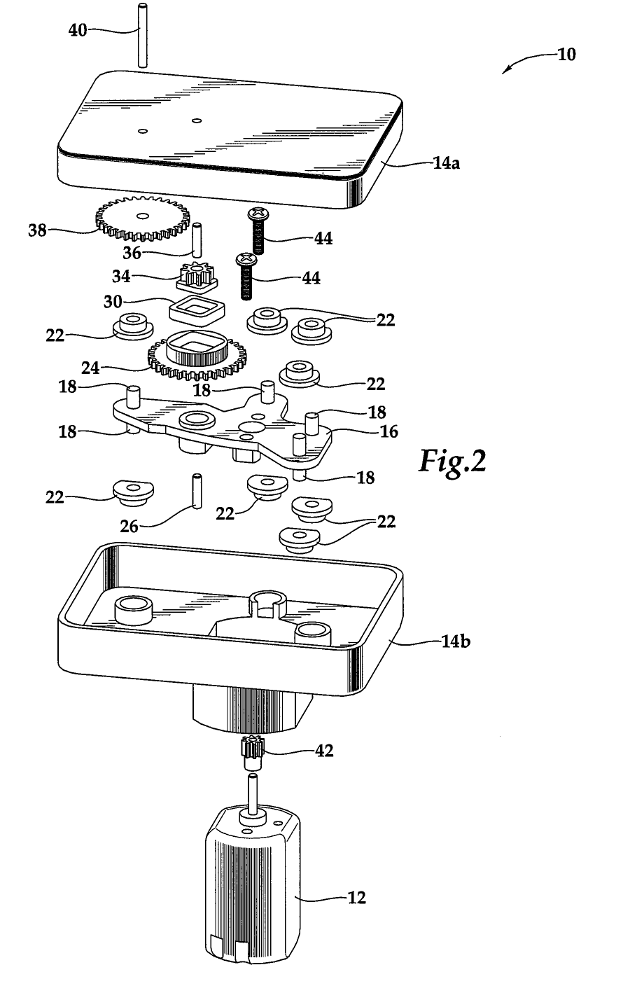

With reference to FIG. 2, an alternate embodiment of an invention for a gearbox 10 includes a motor 12, a housing 14 and a frame 16. The frame 16 is preferably coupled to the housing 14 via a plurality of tabs 18. The plurality of tabs 18 may be inserted into a corresponding plurality of vibration absorbing dampers 22 prior to insertion into a plurality of recesses 20 located in the top housing 14a and the bottom housing 14b. The tabs 18 are preferably integral to and located on the frame 16 to accommodate their insertion into the recesses 20 in the housing 14. Although the number of tabs 18, recesses 20, and dampers 22 shown is eight, any number may be used to provide stable operation of the gearbox 10. In an alternate embodiment, the dampers 22 are integral to the tabs 18. To be integral to the tabs 18, the vibration absorbing material of the dampers 22 may be applied to the tabs 18. Application of the damper 22 vibration absorbing material may be by such means as, but not limited to, painting the tabs 18 or coating, either partially or completely, the tabs 18.

In a preferred embodiment, the frame 16 is coupled to a first gear 24 by an axle 26. The axle 26 may also couple the frame 16 to the bottom housing 14b. The first gear 24 preferably includes a first coupling portion 28. A vibration absorbing adaptor 30 is inserted into the first coupling portion 28. The adaptor 30 contains a second coupling portion 32 into which a second gear 34 is inserted into. Thus, the first gear 24 and the second gear 34 are operably coupled or interlocked via the adaptor 30. The adaptor 30 is preferably designed to transfer the torque from the first gear 24 to the second gear 34. The first gear 24, the adaptor 30, and the second gear 34 are preferably further coupled by an axle 36. The axle 36 may also be coupled to the top housing 14a. In a preferred embodiment, the axle 36 is press fit into a post hole of the top housing 14a and the axle 36, the second gear 34, the adaptor 30, the first gear 24, the frame 16 and axle 26 are assembled along the same center line.

In a preferred embodiment, a third gear 38 is driven by the second gear 34. The third gear 38 is preferably coupled to the top housing 14 via an axle 40.

The motor 12 may be coupled to the first gear 24 via a pinion 42. The pinion 42 preferably drives the first gear 24. The motor 12 is preferably coupled to the frame 16 by a plurality of motor mounting screws 44.

In conclusion, therefore, it is seen that the present invention and the embodiment(s) disclosed herein are well adapted to carry out the objectives and obtain the ends set forth. Certain changes can be made in the subject matter without departing from the spirit and the scope of this invention. It is realized that changes are possible within the scope of this invention and it is further intended that each element or step recited is to be understood as referring to all equivalent elements or steps. The description is intended to cover the invention as broadly as legally possible in whatever forms it may be utilized.

What is claimed is:

1. A gear assembly comprising:
a first gear including a first coupling portion,
a vibration absorbing adaptor coupled with the first coupling portion of the first gear including a second coupling portion,
a second gear coupled with the second coupling portion of the adaptor and driven by the first gear, and
a third gear driven by the second gear,
wherein the first coupling portion, the adaptor, the second coupling portion and the second gear are operably coupled to transfer torque from the first gear to the second gear.

2. The gear assembly of claim 1, wherein the first gear, second gear and third gear are spur gears, crown gears, bevel gears, helical gears, or combinations thereof.

3. The gear assembly of claim 1, wherein the first gear, second gear and third gear are spur gears.

4. The gear assembly of claim 1, wherein the first gear is a crown gear and the second gear and third gear are spur gears.

5. The gear assembly of claim 1, wherein the first gear is a bevel gear and the second gear and third gear are spur gears.

6. The gear assembly of claim 1, further comprising a small frame coupled to a housing and including a plurality of vibration absorbing dampers.

7. The gear assembly of claim 7, wherein the dampers are rubber.

8. The gear assembly of claim 1, wherein the adaptor is rubber.

9. The gear assembly of claim 1, further comprising a DC motor driving the first gear.

10. The gear assembly of claim 1, wherein the adaptor is integral to the second gear.

11. The gear assembly of claim 1, wherein the adaptor is integral to the first gear.

12. The gear assembly of claim 1, wherein the first coupling portion comprises a recess.

13. The gear assembly of claim 1, wherein the second coupling portion comprises a recess.
